(19) United States
(12) Patent Application Publication
(10) Pub. No.: US 2010/0050387 A1
(43) Pub. Date: Mar. 4, 2010

(54) INTERFERENCE ASSEMBLY, HINGE UTILIZING THE SAME, AND COLLAPSIBLE DEVICE UTILIZING THE HINGE

(75) Inventors: SHIN-YUAN WANG, Tu-Cheng (TW); XIN-RU OU-YANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/275,219

(22) Filed: Nov. 21, 2008

(30) Foreign Application Priority Data
Sep. 3, 2008 (CN) 200820302005.X

(51) Int. Cl. E05D 11/10; E05D 11/08

(52) U.S. Cl. 16/342; 16/319

(57) ABSTRACT

An interference assembly comprises a first element defining a first side and a through hole, and a second element rotatably relative to the first element, with defining a first surface facing and corresponding to the first side. Two staggered first raised portions along a circumference of the first element protrude from the first side. Two staggered second raised portions around the through hole protrude from the first side. The first raised portions communicate with the corresponding second raised portions. The second element defines a fixing hole, two first depressed portions staggered along a circumference in the first surface, and two second depressed portions staggered around the fixing hole in the first surface. The first depressed portions also communicate with the corresponding second depressed portions.

### CROSS-REFERENCE TO RELATED APPLICATION

This application is related to a co-pending U.S. patent application, application Ser. No. 12/250487, filed concurrently with the present application, entitled “HINGE AND COLLAPSIBLE DEVICE UTILIZING THE SAME”, which is assigned to the same assignee as that of the present application. The inventor of the co-pending application is Shin-Yuan Wang. The Specification and Drawings of the co-pending application are incorporated herein by reference.

### BACKGROUND

1. Technical Field

The present disclosure relates to interference assemblies and, particularly, to an interference assembly for a hinge and a collapsible device utilizing the hinge.

2. Description of Related Art

A collapsible device, such as a notebook computer, or a clamshell mobile phone, generally including a main body and a display often uses a hinge to interconnect the main body and the display. The hinge allows the display to be rotational with respect to the main body, and to be folded with the main body for saving space.

A hinge normally includes a first element and a second element fixed to the main body and the display of the collapsible device, respectively. The first and second elements are rotational relative to and in friction engagement with each other. The first element includes two raised portions, and the second element includes two depressed portions for receiving the raised portions. During rotation, the raised portions are moved out from the corresponding depressed portions, resulting in friction between the first and second elements for maintaining the display at any angle with respect to the main body. However, the first and second elements are not durable. After frequent usage and due to wear and tear, the first and second elements could no longer fit together tightly, thereby preventing the display from being able to stay at certain desirable positions. Even worse, when one of the first and second elements is worn out, the display cannot maintain stability at almost any angle with respect to the main body, which is quite inconvenient for users.

### BRIEF DESCRIPTION OF THE DRAWINGS

FIG. 1 is an exploded, isometric view of an exemplary embodiment of a hinge including an interference assembly.

FIG. 2 is an enlarged, isometric view of the interference assembly of FIG. 1, the interference assembly includes a first element and a second element rotational relative to the first element.

FIG. 3 is an enlarged, isometric view of the first element of FIG. 2.

FIG. 4 is an enlarged, isometric view of the second element of the FIG. 2.

FIG. 5 is an assembled, isometric view of FIG. 1.

FIG. 6 is an isometric view of an exemplary embodiment of a collapsible device utilizing the hinge of FIG. 1.

### DETAILED DESCRIPTION

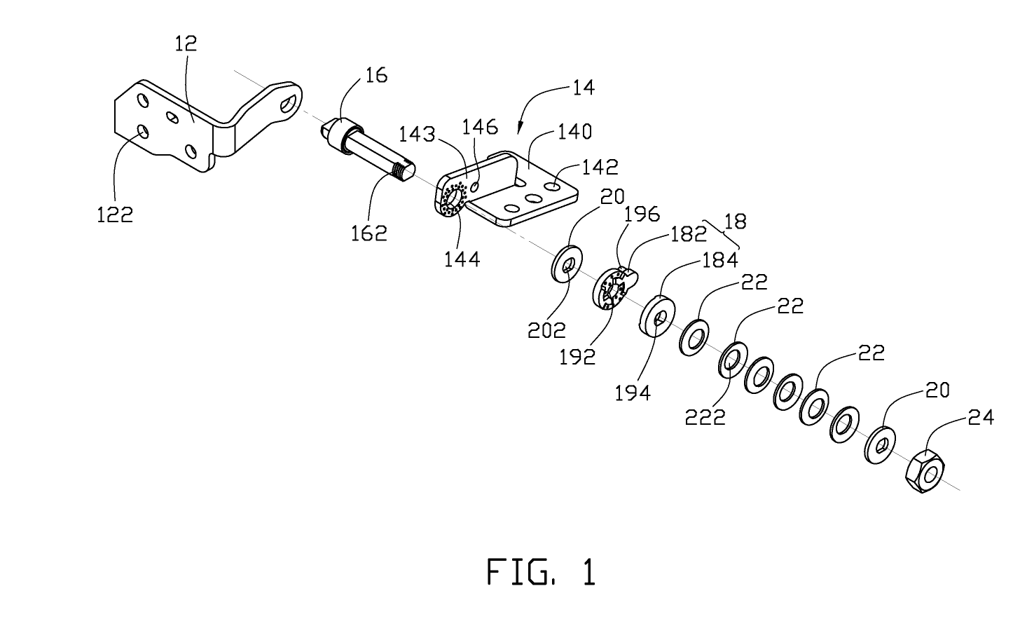

Referring to FIG. 1, an exemplary embodiment of a hinge includes a first connecting member 12, a second connecting member 14, a shaft 16, an interference assembly 18, two friction members 20, a plurality of biasing members 22, and a fastener 24.

The first connecting member 12 defines a plurality of fixing holes 122. Similarly, the second connecting member 14 defines a plurality of fixing holes 142. The first and second connecting members 12, 14 can be rotated relative to each other.

The second connecting member 14 includes a connecting portion 140, and a fixing portion 143 perpendicularly extending from the connecting portion 140. The fixing holes 142 are defined in the connecting portion 140. The fixing portion 143 defines a round through hole 144, and a fixing hole 146 adjacent to the through hole 144.

The shaft 16 is fixed to the first connecting member 12. A distal end of the shaft 16 is non-circular in shape, such as double-D shaped in the illustrated embodiment, and defines a threaded portion 162 thereon. The shaft 16 rotatably extends through the through hole 144 of the second connecting member 14, thereby allowing the second connecting member 14 to rotate freely relative to the shaft 16 and the first connecting member 12.

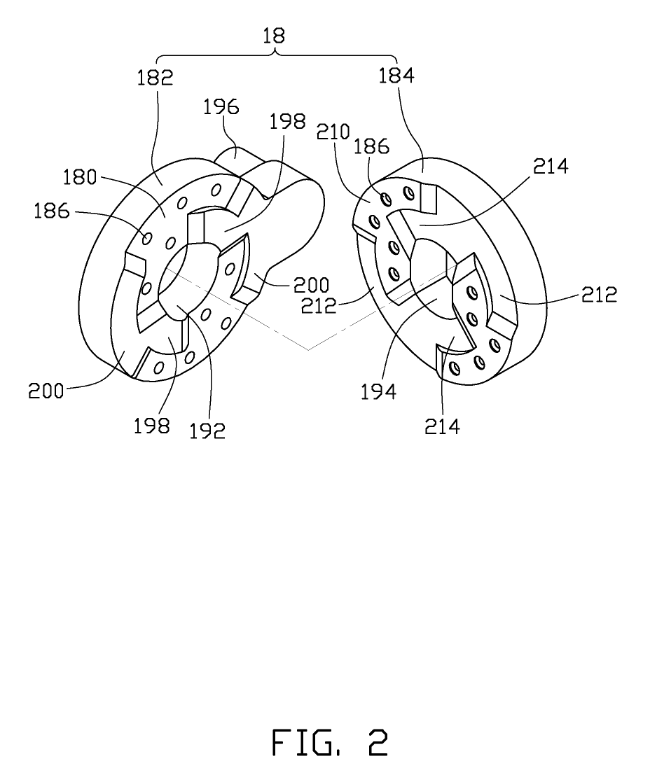

Referring to FIG. 2, the interference assembly 18 is mounted to the shaft 16. The interference assembly 18 includes a generally washer-shaped first element 182, and a generally washer-shaped second element 184.

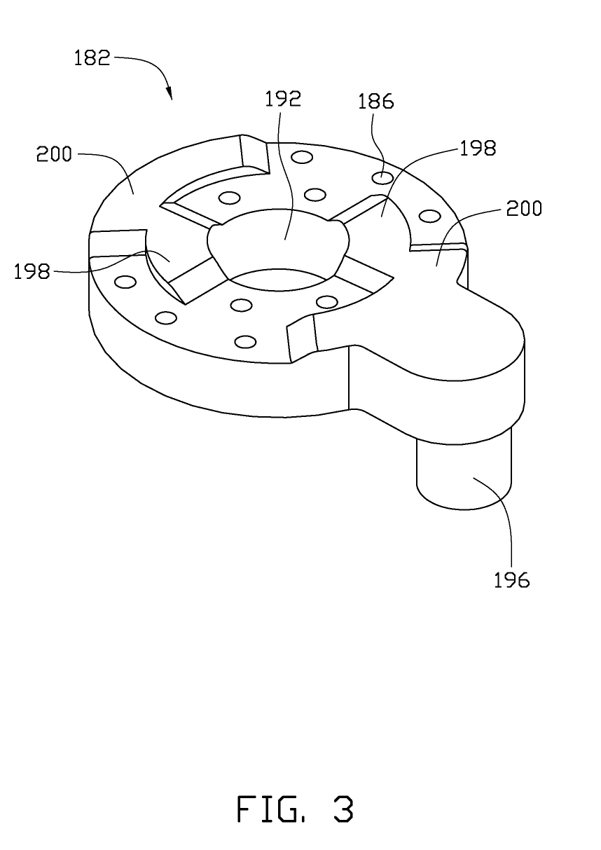

Referring also to FIG. 3, the first element 182 includes a first side 180 facing the second element 184, and defines a round through hole 192 in a center through from the first side 180 to an opposite second side, for the shaft 16 rotatably passing through. Two arc-shaped first raised portions 200 arranged along a circumference of the first element 182 protrude out from the first side 180. The first raised portions 200 are staggered protrusions on the first side 180, and are opposite to each other across the through hole 192.

Two arc-shaped second raised portions 198 arranged around the through hole 192 protrude out from the first side 180, too. The second raised portions 198 are staggered protrusions on the first side 180, and are opposite to each other across the through hole 192. Heights of the second raised portions 198 are substantially equal to heights of the first raised portions 200. One end of each second raised portion 198 communicates with one end of a corresponding first raised portion 200. The first side 180, in between the raised portions 200, 198 defines a plurality of recessed portions 186, capable of retaining lubricant. Each end of the first and second raised portions 200, 198 are slantingly connected to the first side 180. A protrusion (not labeled) extends from the circumference of the first element 182. A fixing post 196 extends away from the first side 180 from the protrusion along an axial direction of the first element 182. The fixing post 196 is fixed in the fixing hole 146, thereby fixing the first element 182 to and moving together with the second connecting member 14.

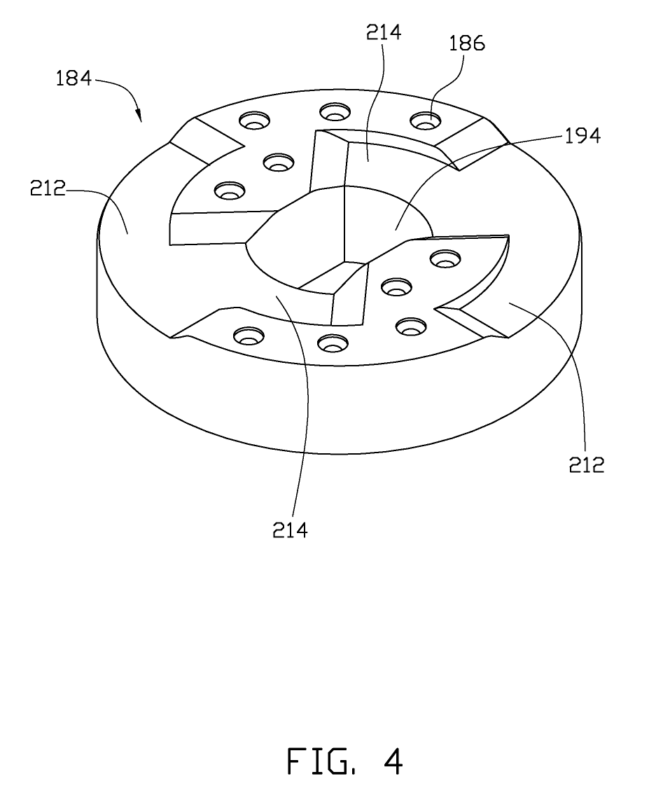

Referring to FIGS. 2 and 4, the second element 184 includes a matching surface 210, and defines a double-D shaped fixing hole 194 in a center, for non-rotationally fitting about the shaft 16. The matching surface 210 faces and engages with the first side 180 of the first element 182. The matching surface 210 defines two first depressed portions 212 engagable with the first raised portions 200, and two second depressed portions 214 engagable with the second raised portions 198. Depths of the first and second depressed portions 212, 214 are substantially equal. The first depressed portions 212 shape similarly to the first raised portions 200, and can receive the first raised portions 200, respectively. The second depressed portions 214 shape similarly to the second raised portions 198, and can receive the second raised portions 198, respectively. Correspondingly, the first depressed portions 212 are staggered along a circumference of the second element 184, in the matching surface 210 and opposite to each other across the fixing hole 194. The second depressed portions 214 are staggered around the fixing hole 194, in the matching surface 210 and opposite to each other across the fixing hole 194. Therefore, depths of the first and second depressed portions 212, 214 are substantially equal to heights of the corresponding first and second raised portion 200, 198. Ends of the first and second depressed portions 212, 214 are slantingly connected to the matching surface 210 of the second element 184. Portions of the matching surface 210, in between the depressed portions 212, 214 define a plurality of recessed portions 186, capable of retaining lubricant.

Each friction member 20 defines a double-D shaped through hole 202 for engaging the shaft 16. The shape of the through hole 202 corresponds to the cross-section of the shaft 16, and thus, the friction members 20 and the shaft 16 are immovable with one another.

Each biasing member 22 is configured to provide elastic forces along an axial direction of the shaft 16 to tighten the friction members 20, the interference assembly 18, and the second connecting member 14. The biasing member 22 defines a round through hole 222 for the shaft 16 passing through, thereby, allowing the shaft 16 to rotate freely relative to the biasing member 22.

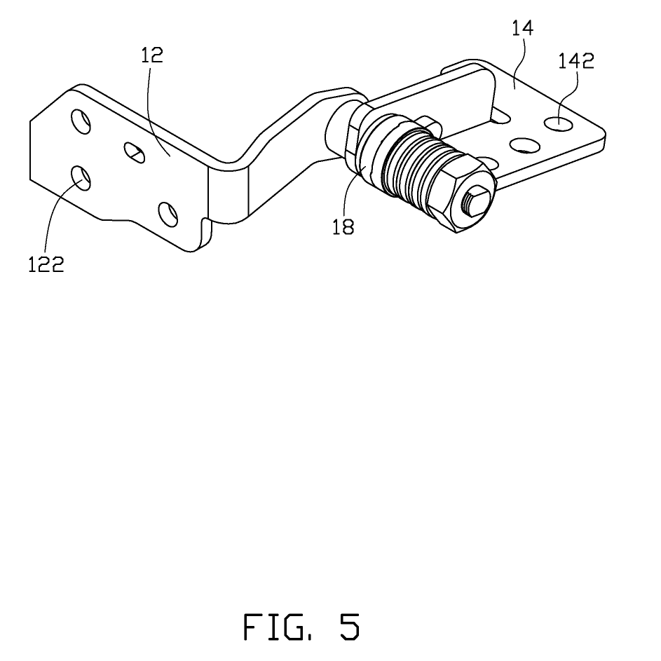

Referring to FIG. 5, in assembly, the threaded portion 162 of the shaft 16 is passed through the through hole 144 of the second connecting member 14, the through hole 202 of one of the friction members 20, the through hole 192 of the first element 182, the fixing hole 194 of the second element 184, the through holes 222 of the biasing members 22, and the through hole 202 of the other friction member 20 in turn. The fastener 24 is engaged with the threaded portion 162 for fixing the fastener 24 to the shaft 16, which is configured for preventing the friction members 20, the biasing members 22, the first element 182, and the second element 184 from disengaging from the shaft 16.

In the aforementioned assembly, the fixing post 196 of the first element 182 is inserted into the fixing hole 146 of the second connecting member 14, thereby allowing the second connecting member 14 non-rotationally fitting about the first element 182. One of the friction members 20 is mounted between the second connecting member 14 and the first element 182, with immovably fitted about and rotated with the shaft 16. The second element 184 is immovably mounted to and rotated with the shaft 16, with the matching surface 210 engagable with the first side 180 of the first element 182.

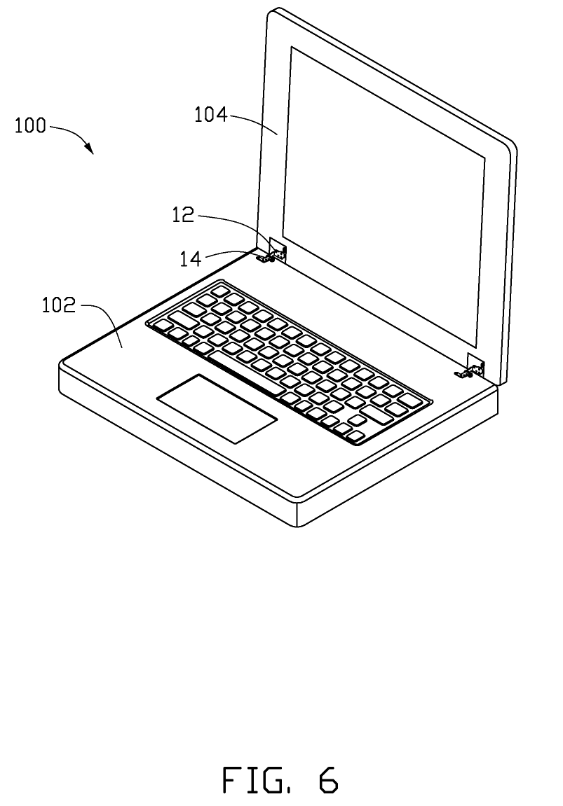

Referring to FIG. 6, in use, the above-mentioned hinge is utilized in a collapsible device 100, here for instance, in a notebook computer that includes a base 102 and a cover 104. The fixing holes 122 are configured for allowing fastening members, such as screws, bolts, or rivets, etc., to extend through, thereby fixing the first connecting member 12 to the cover 104. Similarly, the fixing holes 142 are configured for allowing fastening members, such as screws, bolts, or rivets, etc., to extend through, thereby fixing the second connecting member 14 to the base 102. Therefore, during the rotation of the cover 104, the first connecting member 12 is rotated relative to the second connecting member 14, together with the shaft 16, the friction members 20, and the second element 184. As a result, the first raised portions 200 are engaged in or disengaged from the corresponding first depressed portions 212, synchronically with the second raised portions 198 of the first element 182 engaged in or disengaged from the corresponding second depressed portions 214. Therefore, the biasing members 22 are distorted for providing elastic forces along an axial direction to tighten the friction members 20, the interference assembly 18. As a result, friction between the friction member 20 and the first element 182 positions the cover 104 maintaining stability at any angle with respect to the base 102. Moreover, the first and second elements 182, 184 can remain in constant contact with each other over time by the elastic forces. In addition, in the closing movement, the first and second raised portions 200, 198 slide to enter into the first and second depressed portions 212, 214. When the first and second raised portions 200, 198 are positioned at edges of the first and second depressed portions 212, 214, the cover 102 may be physically released because the cover 102 will continue to rotate by force of inertia, but gently so as not to bump hard against the base 104.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. An interference assembly comprising:
a first element defining a through hole comprising:
a first side;
two staggered first raised portions protruding from the first side, the first raised portions arranged along a circumference of the first element and opposite to each other across the through hole;
two staggered second raised portions protruding from the first side, the second raised portions arranged around and opposite to each other across the through hole, wherein one end of each first raised portion communicates with a corresponding end of a corresponding second raised portion; and
a second element defining a fixing hole comprising:
a matching surface corresponding to the first side of the first element;
two first depressed portions defined and staggered in the matching surface, wherein the first depressed portions are arranged around and opposite to each other across the fixing hole;
two second depressed portions defined and staggered in the matching surface, wherein the second depressed portions are arranged along a circumference of the second element and opposite to each other across the fixing hole, one end of each first depressed portion communicates with a corresponding end of a corresponding second depressed portion;
wherein the second element is rotatable relative to the first element, with the matching surface facing the first side, and the first raised portions are capable of engaging in or disengaging from the first depressed portions, the second raised portions are capable of engaging in or disengaging from the second depressed portions.

2. The interference assembly of claim 1, wherein heights of the second raided portions are substantially equal to heights of the first raised portions.

3. The interference assembly of claim 1, wherein depths of the first depressed portions are substantially equal to depths of the second depressed portions.

4. The interference assembly of claim 3, wherein depths of the first and second depressed portions substantially equal to heights of the corresponding first and second raised portions.

5. The interference assembly of claim 1, wherein the first element comprises a fixing post; the fixing post extends from a circumference of the first element and away from the first side, and configured for fixing the first element to a structure.

6. A hinge comprising:
a first connecting member;
a shaft, fixed to the first connecting member, comprising a distal end of the shaft defining a threaded portion;
a second connecting member defining a through hole for rotationally fitting about the shaft;
an interference assembly comprising:
a first element defining a through hole for rotationally fitting about the shaft, the first element comprising:
a first side;
two staggered first raised portions protruding from the first side, the first raised portions arranged along a circumference of the first element and opposite to each other across the through hole;
two staggered second raised portions protruding from the first side, the second raised portions arranged around and opposite to each other across the through hole, wherein one end of each first raised portion communicates with a corresponding end of a corresponding second raised portion; and
a second element defining a fixing hole for unrotatably fitting about the shaft, the second element comprising:
a matching surface corresponding to the first side of the first element;
two first depressed portions defined and staggered in the matching surface, the first depressed portions arranged around and opposite to each other across the fixing hole;
two second depressed portions defined and staggered in the matching surface, the second depressed portions arranged along a circumference of the second element and opposite to each other across the fixing hole, wherein one end of each first depressed portion communicates with a corresponding end of a corresponding second depressed portion;
a plurality of biasing members rotationally fitting about the shaft; and
a fastener engaged with the threaded portion and configured for keeping the second connecting member, the interference assembly and the plurality of biasing members from being disengaged from the shaft;
wherein the second element is rotatable relative to the first element, with the matching surface facing the first side, and the first raised portions are capable of engaging in or disengaging from the first depressed portions, the second raised portions are capable of engaging in or disengaging from the second depressed portions.

7. The hinge of claim 6, wherein heights of the second raided portions are substantially equal to heights of the first raised portions.

8. The hinge of claim 6, wherein depths of the first depressed portions are substantially equal to depths of the second depressed portions.

9. The hinge of claim 8, wherein depths of the first and second depressed portions substantially equal to heights of the corresponding first and second raised portions.

10. The hinge of claim 6, wherein the first element defines a fixing post extending from a circumference thereof and away from the first side; the fixing post is engaged in the fixing hole.

11. The hinge of claim 6, further comprising a friction member immovably fixed to the shaft, wherein the friction members is positioned between the second connecting member and the first element.

12. The hinge of claim 11, wherein the friction member defines a through hole for allowing the shaft passing through, and in friction engagement with the first element.

13. A collapsible device comprising:
a base;
a hinge comprising:
a first connecting member;
a shaft, fixed to the first connecting member, comprising a distal end of the shaft defining a threaded portion;
a second connecting member defining a through hole for rotationally fitting about the shaft;
an interference assembly comprising:
a first element defining a round through hole for rotationally fitting about the shaft, the first element comprising:
a first side;
two staggered first raised portions protruding from the first side, the first raised portions arranged along a circumference of the first element and opposite to each other across the through hole;
two staggered second raised portions protruding from the first side, the second raised portions arranged around and opposite to each other across the through hole, wherein one end of each first raised portion communicates with a corresponding end of a corresponding second raised portion; and
a second element defining a fixing hole for unrotatably fitting about the shaft, the second element comprising:
a matching surface corresponding to the first side of the first element;
two first depressed portions defined and staggered in the matching surface, the first depressed portions arranged around and opposite to each other across the fixing hole;
two second depressed portions defined and staggered in the matching surface, the second depressed portions arranged along a circumference of the second element and opposite to each other across the fixing hole, wherein one end of each first depressed portion communicates with a corresponding end of a corresponding second depressed portion;
a plurality of biasing members rotationally fitting about the shaft; and
a fastener engaged with the threaded portion and configured for keeping second connecting member, interference assembly and the plurality of biasing members from being disengaged from the shaft; and
a cover pivotally mounted to the base via the hinge;
wherein the first connecting member is fixed to the cover, and the second connecting member is fixed to the base, the second element is rotatable relative to the first element, with the matching surface facing the first side, and the first raised portions are capable of engaging in or disengaging from the first depressed portions, the second raised portions are capable of engaging in or disengaging from the second depressed portions.

14. The collapsible device of claim 13, wherein heights of the second raided portions are substantially equal to heights of the first raised portions.

15. The collapsible device of claim 13, wherein depths of the first depressed portions are substantially equal to depths of the second depressed portions.

16. The collapsible device of claim 15, wherein depths of the first and second depressed portions substantially equal to heights of the corresponding first and second raised portions.

17. The collapsible device of claim 13, wherein the second connecting member defines a fixing hole; the first element defines a fixing post extending from a circumference thereof and away from the first side; the fixing post is engaged in the fixing hole.

18. The collapsible device of claim 13, wherein the hinge further comprises a friction member immovably fixed to the shaft, wherein the friction member is positioned between the second connecting member and the first element.

19. The collapsible device of claim 18, wherein the friction member defines a through hole for unrotatably allowing the shaft passing through, and in friction engagement with the first element.
